(19) United States
(12) Patent Application Publication
(10) Pub. No.: US 2011/0207512 A1
(43) Pub. Date: Aug. 25, 2011

(54) Arching game system

(75) Inventor: Chih-Chieh Wang, Taichung City (TW)

(73) Assignee: Youal-Jifh Enterprise Co., Ltd.

(21) Appl. No.: 12/660,218

(22) Filed: Feb. 23, 2010

(51) Int. Cl. A63F 13/00

(52) U.S. Cl. 463/5

(57) ABSTRACT

Disclosed is an arching game system including a bow-and-arrow set, a display and a visual identification unit. The bow-and-arrow includes a bow, a buffer, a string and an arrow. The bow includes an aperture defined therein. The buffer is attached to the bow. The string is tied to the bow. The arrow is movably connected to the bow. The arrow includes a pile, a butt and a shaft extending between the pile and the butt. The butt is movable against the string so that the string shoots the arrow on release of the butt. The buffer buffers the arrow. The arrow is aimed at a target shown on the display. The visual identification unit determines the direction of the travel of the arrow and the force exerted on the arrow.

### BACKGROUND OF INVENTION

1. Field of Invention

The present invention relates to a game machine and, more particularly, to an arching game system.

2. Related Prior Art

Game machines are popular among youngsters. Conventional game machines include joysticks and buttons operable to play games. The conventional game machines however fail to lure youngsters to move their bodies during the proceeding of the games. Youngsters do not exercise their bodies and improve their sense of balance while playing with the conventional game machines.

Some other game machines include drumsticks, hammers or pistol-shaped laser pointers, operable to play games. Some other game machines include hand-held motion sensors operable to play games. Some other game machines include sensors for sensing balls sunk through rims. These game machines lure youngsters to move their bodies during the proceeding of the games. Therefore, these game machines are the most popular ones among youngsters who like to combine exercise with fun.

There have been various game machines to provide different sorts of fun and exercises to users. However, there are always needs for new game machines to provide new sorts of fun and exercises to users.

### SUMMARY OF INVENTION

It is the primary objective of the present invention to provide an arching game system.

According to the present invention, the arching game system includes a bow-and-arrow set, a display and a visual identification unit. The bow-and-arrow includes a bow, a buffer, a string and an arrow. The bow includes an aperture defined therein. The buffer is attached to the bow. The string is tied to the bow. The arrow is movably connected to the bow. The arrow includes a pile, a butt and a shaft extending between the pile and the butt. The butt is movable against the string so that the string shoots the arrow on release of the butt. The buffer buffers the arrow. The arrow is aimed at a target shown on the display. The visual identification unit determines the direction of the travel of the arrow and the force exerted on the arrow.

Other objectives, advantages and features of the present invention will be apparent from the following description referring to the attached drawings.

### BRIEF DESCRIPTION OF DRAWINGS

The present invention will be described via detailed illustration of three embodiments referring to the drawings wherein:

FIG. 1 is a perspective view of an arching game system according to the first embodiment of the present invention;

FIG. 2 is an exploded view of a bow-and-arrow set of the arching game system shown in FIG. 1;

FIG. 3 is an enlarged, partial, perspective view of the bow-and-arrow set shown in FIG. 2;

FIG. 4 is a perspective view of the bow-and-arrow set shown in FIG. 1;

FIG. 5 is a cut-away view of the bow-and-arrow set in another position than shown in FIG. 4;

FIG. 6 is a cross-sectional view of the bow-and-arrow set in another position than shown in FIG. 5;

FIG. 7 is another perspective view of the bow-and-arrow set of FIG. 4, showing, in phantom lines, a string of the bow-and-arrow set pulled;

FIG. 8 is a simplified top view of the arching game system shown in FIG. 1;

FIG. 9 is a simplified perspective view of the arching game system shown in FIG. 1;

FIG. 10 is a flow chart of a method for keeping scores of arching with the arching game system shown in FIG. 1;

FIG. 11 is a cross-sectional view of a bow-and-arrow set according to the second embodiment of the present invention;

FIG. 12 is a cross-sectional view of the bow-and-arrow set in another position than shown in FIG. 11;

FIG. 13 is a cross-sectional view of a bow-and-arrow set according to the third embodiment of the present invention; and

FIG. 14 is a cross-sectional view of the bow-and-arrow set in another position than shown in FIG. 13.

### DEBUTTED DESCRIPTION OF EMBODIMENTS

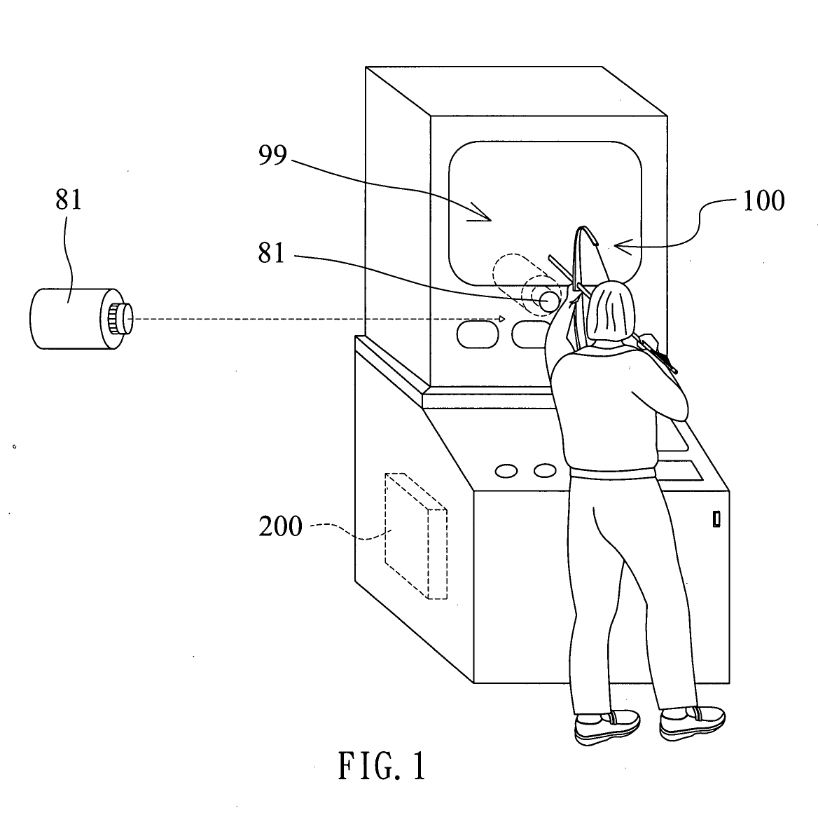

Referring to FIG. 1, an arching game system includes a bow-and-arrow set 100, a display 99 and a visual identification unit 200 according to a first embodiment of the present invention. The display 99 and the visual identification unit 200 are preferably built in an arching game machine.

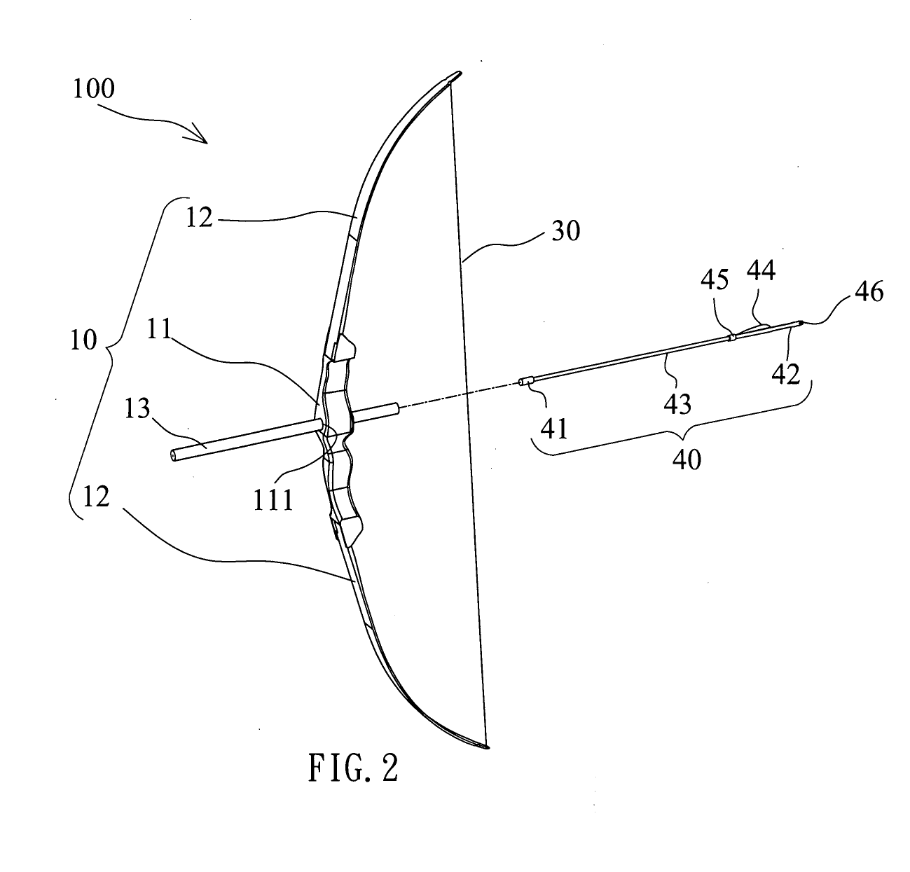

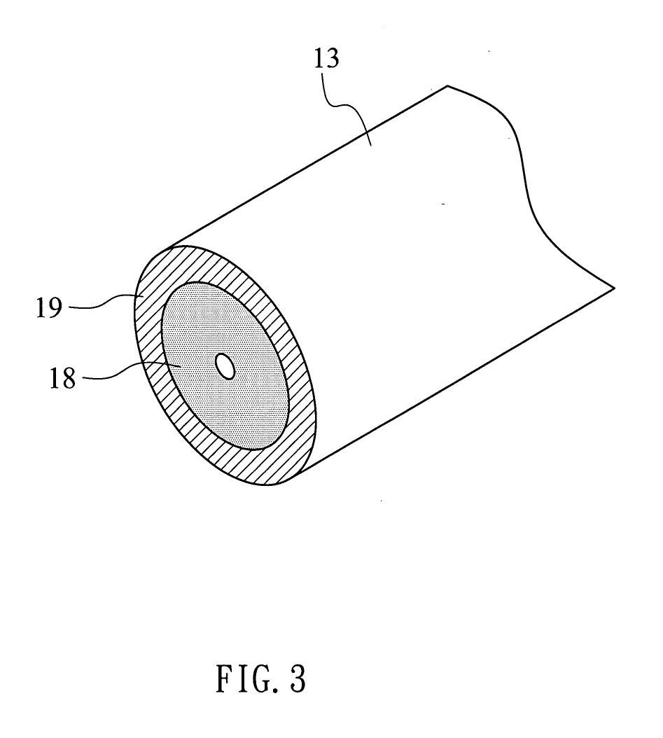

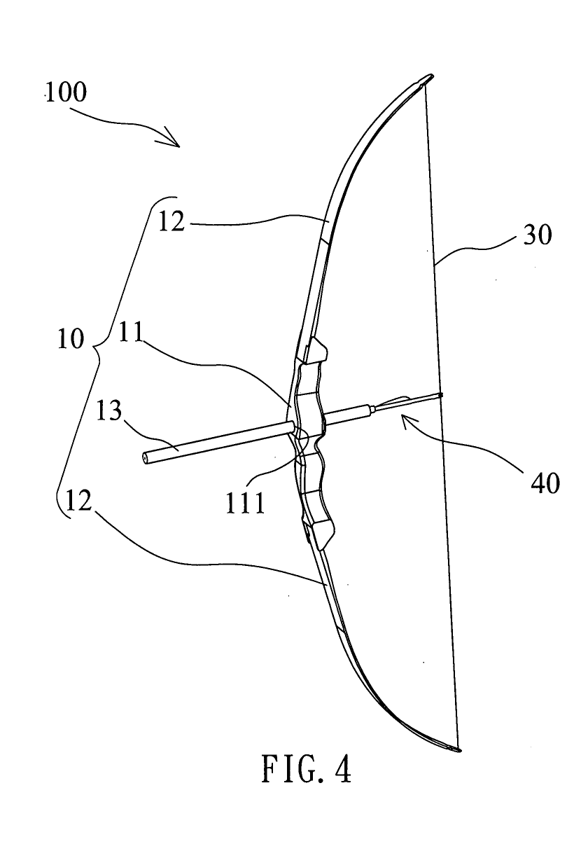

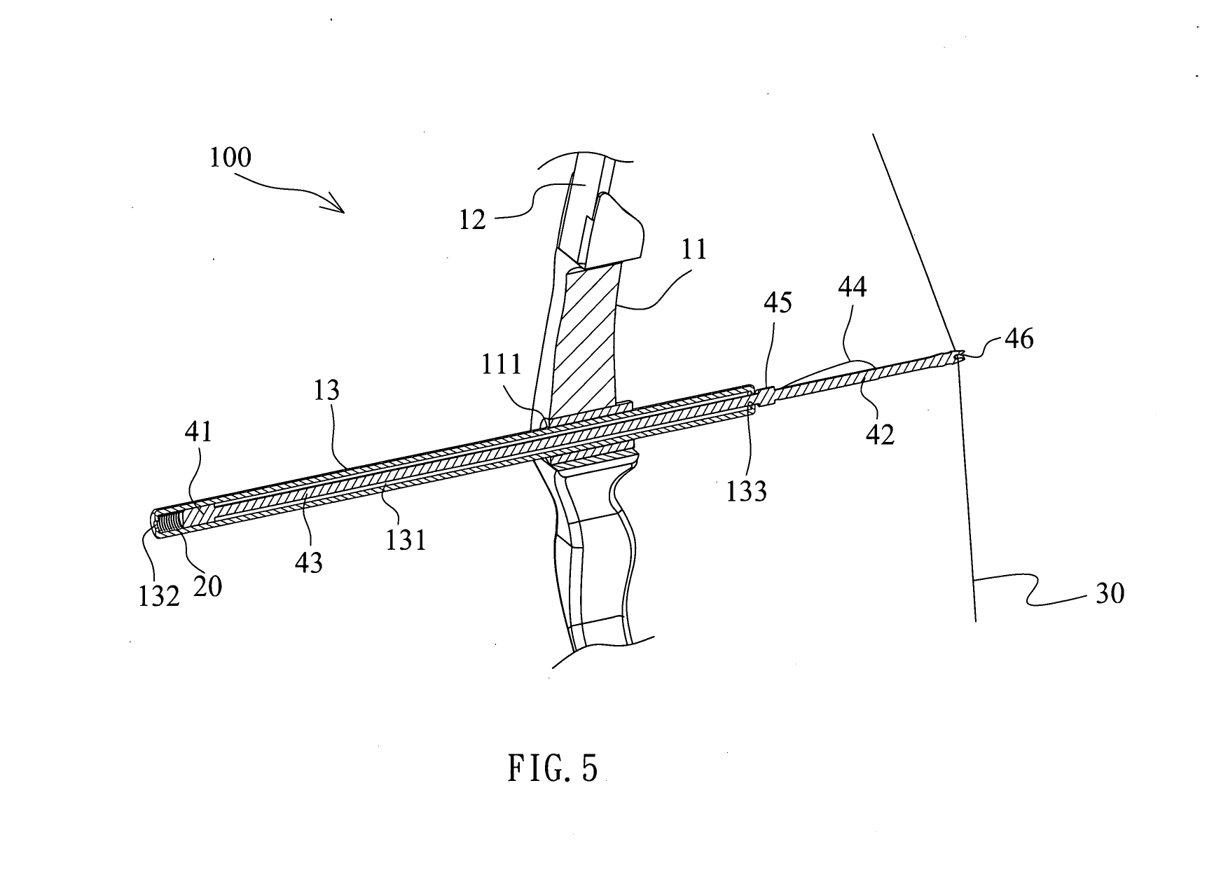

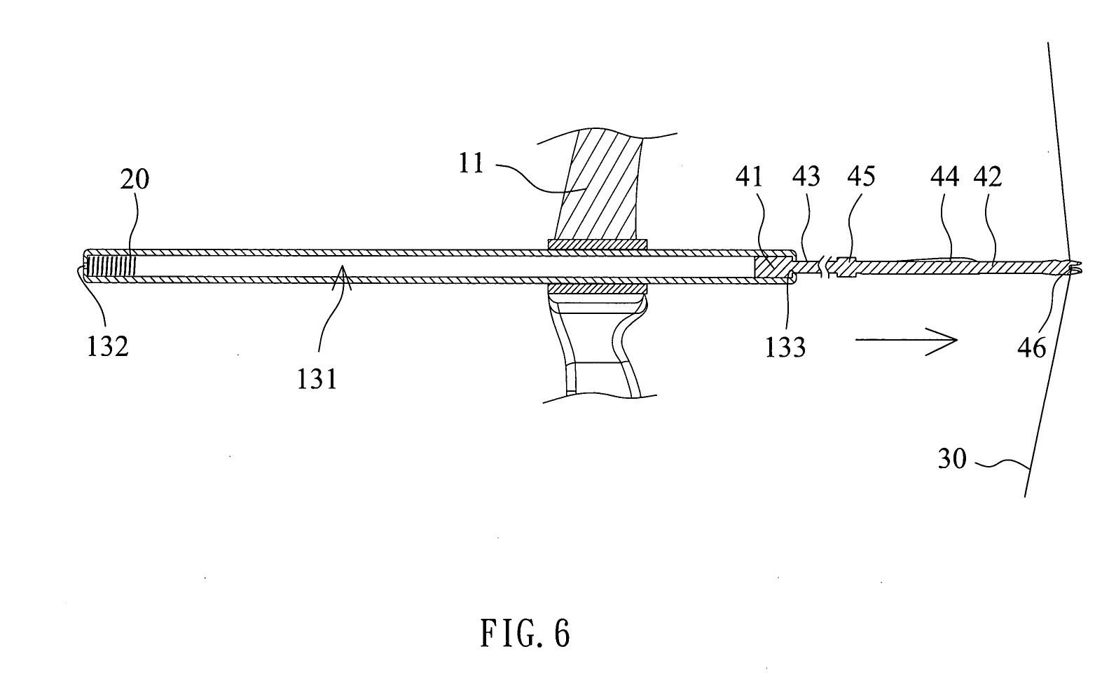

Referring to FIGS. 2 to 7, the bow-and-arrow set 100 includes a bow 10, a buffer 20, a string 30 and an arrow 40. The bow 10 includes a handle 11, two limbs 12 and a pipe 13. The handle 11 is located between the limbs 12. Each end of the handle 11 is secured to an end of a related one of the limbs 12. The limbs 12 are made of an elastic material. The pipe 13 is inserted through an aperture 111 defined in the handle 11. The pipe 13 is secured to the handle 11. The pipe 13 includes a channel 131 defined therein, a vent 132 at a first end of the channel 131, and an aperture 133 at a second end of the channel 131 opposite to the first end. The diameter of the channel 131 is larger than that of the vent 132. A mark 16 is provided on a side of a middle portion of the bow 10. The mark 16 is in a predetermined color. The diameter of the channel 131 is larger than that of the aperture 133. Two color rings 18 and 19 are co-centrically provided at an end of the pipe 13, around the vent 132. The color rings 18 and 19 are in different colors.

The buffer 20 is located within the channel 131, near the vent 132. The diameter of the buffer 20 is larger than that of the vent 132 so that the buffer 20 cannot be removed from the channel 131 via the vent 132. The diameter of the buffer 20 is smaller than that of the channel 131, leaving a first gap between the buffer 20 and an internal side of the pipe 13. The first gap is in communication with the vent 132. The buffer 20 can be a block of an elastic material such as rubber and silicone. Alternatively, the buffer 20 can be a device such as a compression spring, an air bag and a pneumatic or hydraulic cylinder. The buffer 20 is a block of rubber in this embodiment.

The string 30 includes two ends each tied to another end of a related one of the limbs 12. The ends of the string 30 are tied to the limbs 12 after the limbs 12 are bent. Thus, the string 30 is loaded.

The arrow 40 includes a pile 41, a butt 42, a shaft 43 extending between the pile 41 and the butt 42, at least one fletching 44 attached to the butt 42, a stop 45 formed between the butt 42 and the shaft 43, and a nock or recess 46 defined in the butt 42. The diameter of the pile 41 is larger than that of the shaft 43. The diameter of the stop 45 is also larger than that of the shaft 43.

The pile 41 is located within the channel 131, with the buffer 20 located between the pile 41 and the vent 132. The diameter of the pile 41 is smaller than that of the channel 131 so that the pile 41 is movable within and along the channel 131. The diameter of the pile 41 is larger than that of the aperture 133 so that the pile 41 cannot be removed from the channel 131 through the aperture 133.

The butt 42 and the stop 45 are located outside the channel 131, with the shaft 43 inserted through the aperture 133. The diameter of the stop 45 is larger than that of the aperture 133 so that the stop 45 cannot be moved into the channel 131 through the aperture 133. The diameter of the shaft 43 is smaller than that of the aperture 133, leaving a second gap between the shaft 43 and an annular edge within which the aperture 133 is defined.

An archer holds the handle 11 with a hand and holds the butt 42 with the other hand. The archer locates a section of the string 30 within the nock 46 beforehand to make sure that the butt 42 is located against the string 30. The archer pulls the butt 42, thus further loading the string 30. The archer releases the butt 42 to shoot the arrow 40. The pile 41 moves within and along the channel 131 as the arrow 40 travels. As the pile 41 travels along the channel 131, some air is expelled from the channel 131 via the first gap and the vent 132 while other air is pumped into the channel 131 through the second gap. The use of the first and second gaps and the vent 132 are important. Otherwise, the pneumatic pressure would build up in a section of the pipe 13 near the first end, and vacuum would occur in another section of the pipe 13 near the second end. Such increase of the pneumatic pressure and such vacuum would interfere with the movement of the pile 41 within the channel 131. The pile 41 hits the buffer 20 just before the stop 45 hits the second end of the pipe 13. The arrow 40 is stopped.

Advantageously, the arrow 40 cannot be detached from the bow 10. The arrow 40 does not travel for a long distance and cannot hurt any one. Hence, it does not require a large space to arch with the bow-and-arrow set 100. The archer can train his or her body and mind almost anywhere, at any time.

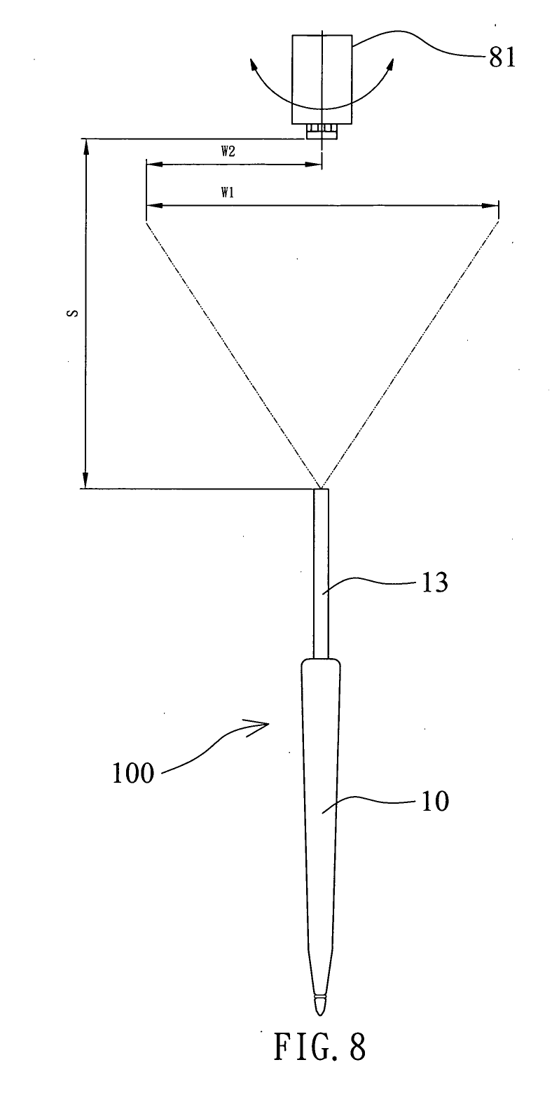

Referring to FIGS. 1 and 8, the visual identification unit 200 includes a first camera 81 for taking a front view of the bow-and-arrow set 100. From the front view, the direction of the arrow 40 can be determined. The color rings 18 and 19 are useful for the first camera 81 to identify the pipe 13 and hence the arrow 40 as the arrow 40 is axially movable in the pipe 13. The first camera 81 is located from the bow-and-arrow set 100 by a distance S. The term “W1” stands for the width of a screen of the display 99. The term “W2” represents half of the width W1.

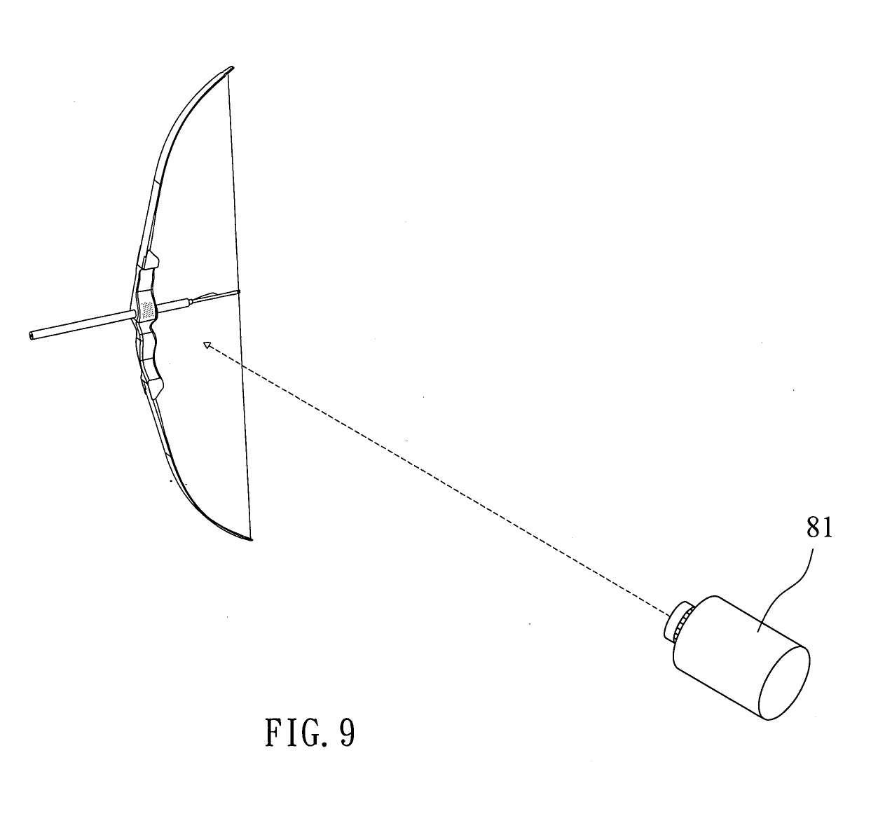

Referring to FIGS. 1 and 9, the visual identification unit 200 includes a second camera 81 for taking a side view of the bow-and-arrow set 100. In the side view of the bow-and-arrow set 100, the mark 16 is identified to facilitate determining the elevation of the bow-and-arrow set 100 and the distance of the bow-and-arrow set 100 from the display 99. From the side view, the force exerted on the string 30 and the phantom distance of the travel of the arrow 40 are calculated.

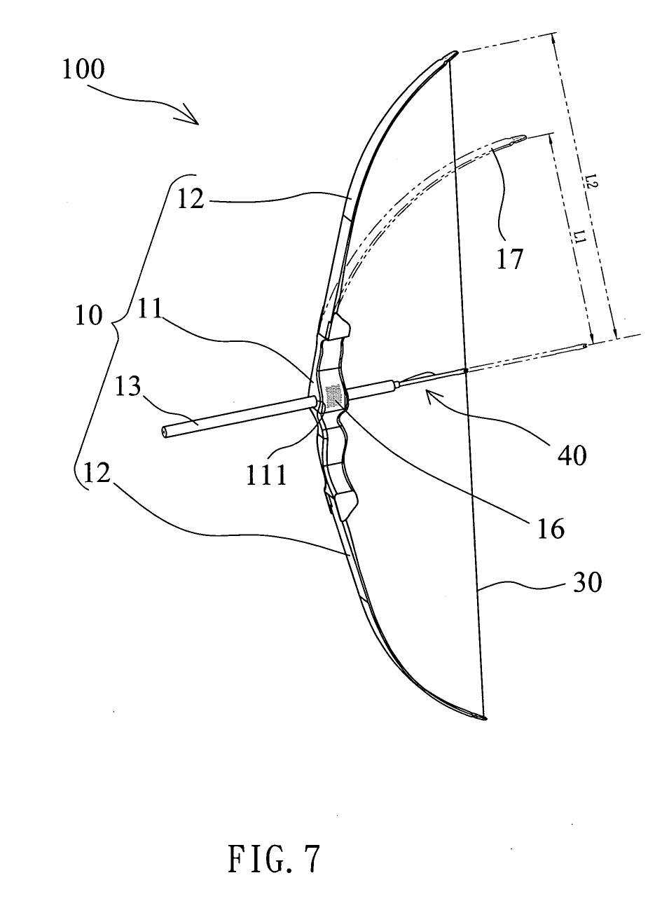

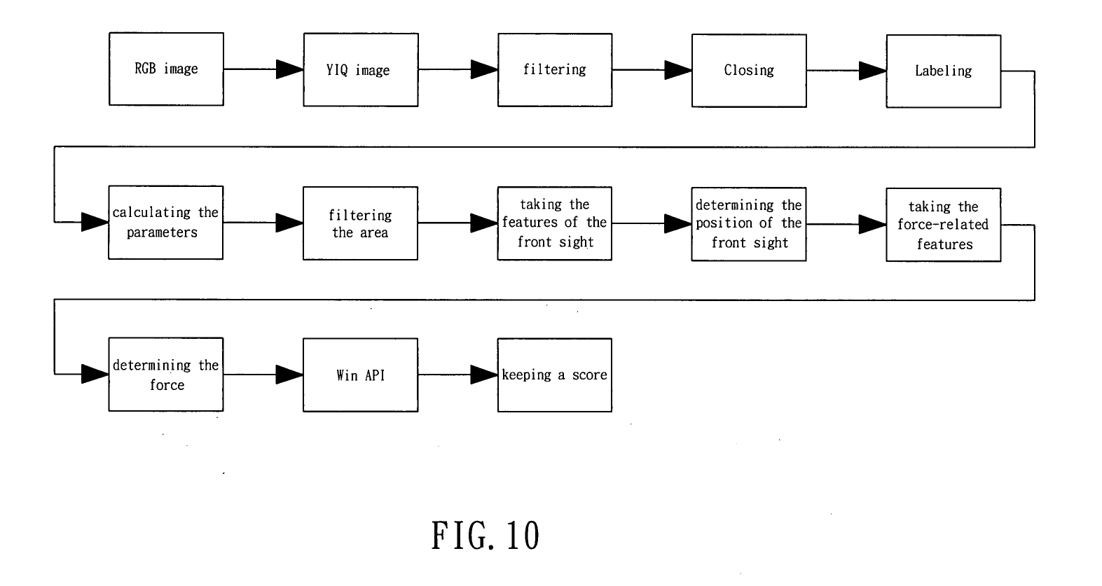

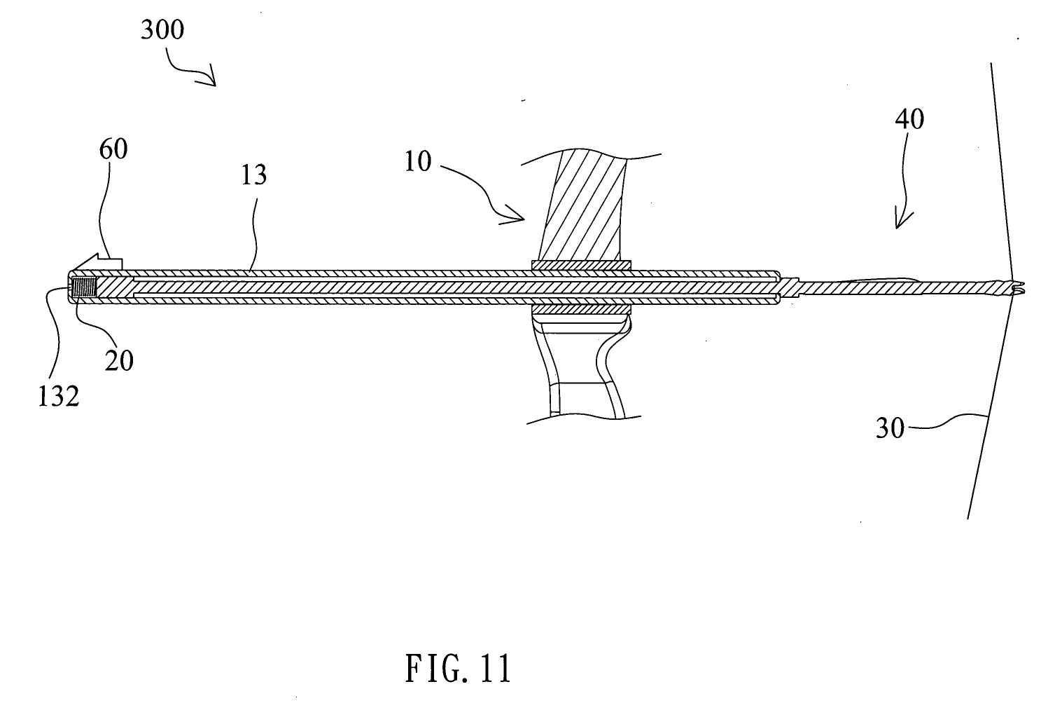

Referring to FIG. 10, there is shown a method for keeping scores of arching with the arching game system. According to the method, an RGB image taking is taken. The RGB image is converted into a YIQ image to expedite the processing. Each pixel of the YIQ image is expressed in two digits by filtering. Objects are separated from one another by closing and labeling. The color rings 18 and 19 are useful for the separation of the objects. The parameters are calculated. The area is filtered. Features of a front sight such as the one shown in FIGS. 11 to 14 are taken. The position of the front sight is determined. Force-related features represented by the terms “L1” and “L2” (FIG. 7) are taken. The term “L1” stands for half of the distance between the tips of the limbs 12 when the string 30 is pulled by an archer. The term “L2” represents half of the distance between the tips of the limbs 12 when the string 30 is released. The force is determined. Win API is run. Finally, a score is kept.

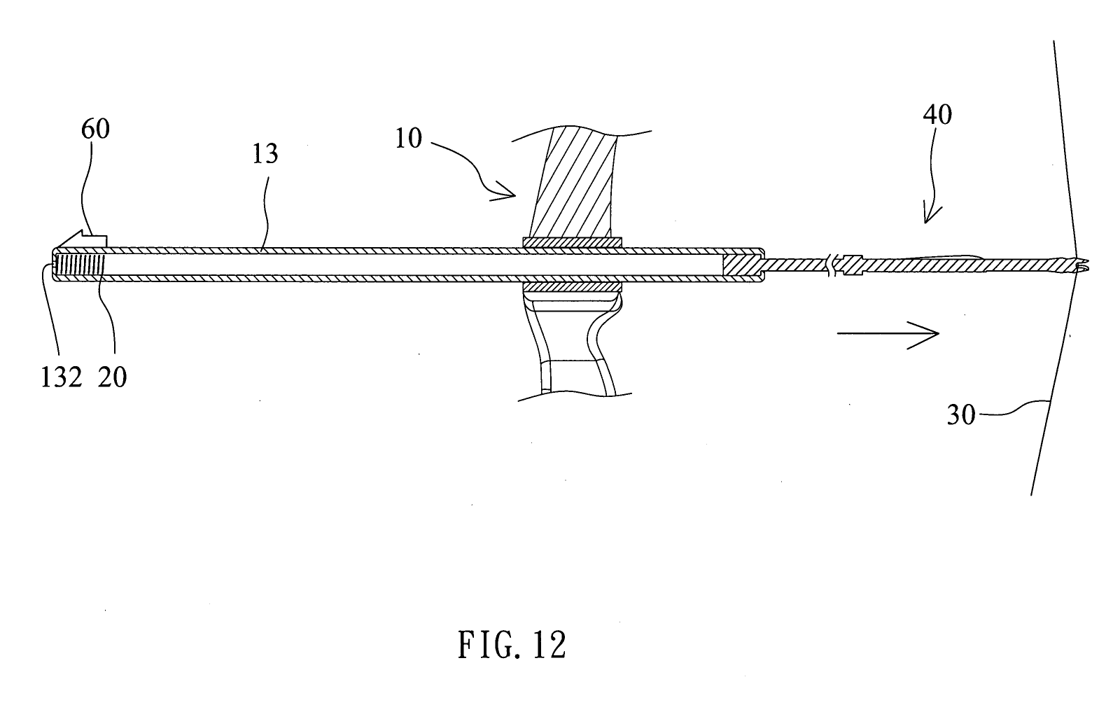

Referring to FIGS. 11 and 12, there is shown a bow-and-arrow set 300 according to a second embodiment of the present invention. The second embodiment is like the first embodiment except including a front sight 60. The front sight 60 can be a mechanical front sight or laser-emitting front sight. The front sight 60 is useful in helping the archer aim at a target.

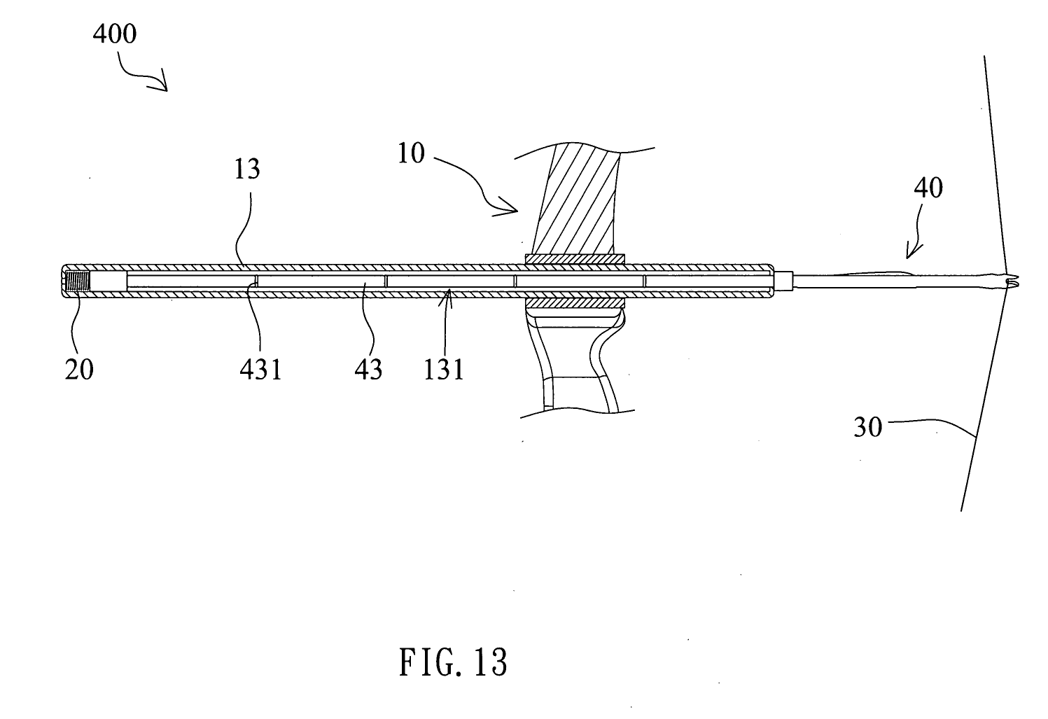

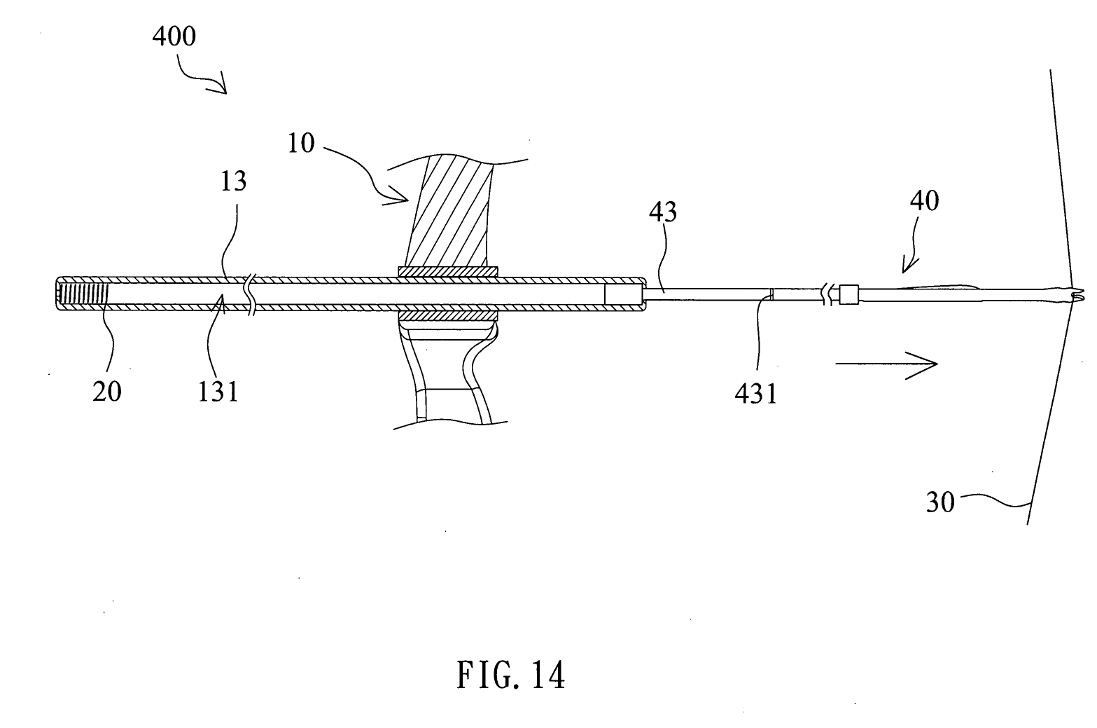

Referring to FIGS. 13 and 14, there is shown a bow-and-arrow set 400 according to a third embodiment of the present invention. The third embodiment is like the first embodiment except including color rings 431 around and evenly along the shaft 43. The visual identification unit 200 can see the color rings 431 and count the number of color rings 431 located outside the pipe 13 to determine the value of a force exerted on the arrow 40 and the string 30. The color rings 431 can be replaced with colored annular stripes in another embodiment.

This invention has been described via the detailed illustration of the embodiments from which those skilled in the art can derive variations without departing from the scope of this invention. Therefore, the embodiments shall not limit the scope of the present invention defined in the claims.

1. An arching game system comprising:
a bow-and-arrow set including a bow (10) including an aperture (111) defined therein, a buffer (20) attached to the bow (10), a string (30) tied to the bow (10), and an arrow (40) movably connected to the bow (10) and formed with a pile (41), a butt (42) and a shaft (43) extending between the pile (41) and the butt (42), wherein the butt (42) is movable against the string (30) so that the string (30) shoots the arrow (40) on release of the butt (42), wherein the buffer (20) buffers the arrow (40);
a display (99) for displaying at least one target at which the arrow (40) is aimed; and
a visual identification unit (200) for determining the direction of the travel of the arrow (40) and the force exerted on the arrow (40).

2. The arching game system according to claim 1, wherein the bow (10) includes a handle (11) and two limbs (12) each connected to an end of the handle (11), wherein the aperture (111) is defined in the handle (11).

3. The arching game system according to claim 1, wherein the bow (10) includes a pipe (13) inserted through the aperture (111), wherein the buffer (20) is located in the pipe (13), wherein the pile (41) is movable in the pipe (13) while the butt (42) is movable against the string (30) so that the string (30) shoots the arrow (40) to move the pile (41) within the pipe (30) on release of the butt (42), wherein the buffer (20) buffers the pile (41).

4. The arching game system according to claim 3, wherein the bow (10) includes a front sight (60) connected to the pipe (13).

5. The arching game system according to claim 3, wherein the pipe (13) includes a vent (132) via which air is expelled from the pipe (13) when the pile (41) moves towards the buffer (20).

6. The arching game system according to claim 5, wherein the pipe (13) includes a channel (131) in communication with the vent (132), wherein the channel (131) includes a diameter larger than that of the vent (132).

7. The arching game system according to claim 1, wherein the pile (41) includes a diameter larger than that of the shaft (43) and larger than that of the aperture (111) so that arrow (40) is kept on the bow (10).

8. The arching game system according to claim 1, wherein the arrow (40) includes at least one fletching (44) attached to the butt (42).

9. The arching game system according to claim 1, wherein the arrow (40) includes a stop (45) formed between the butt (42) and the shaft (43), wherein the stop (45) can abut the bow (40) to avoid insertion of the butt (42) through the aperture (111).

10. The arching game system according to claim 1, wherein the arrow (40) includes a nock (46) for receiving a section of the string (30).

11. The arching game system according to claim 1, wherein the arrow (40) includes color rings (431) provided around the shaft (43).

12. The arching game system according to claim 11, wherein the visual identification unit (200) identifies determines the force exerted on the arrow (40) and the string based on the color rings (431).

13. The arching game system according to claim 1, wherein the visual identification unit (200) includes at least one camera (81) for taking images of the bow-and-arrow set (100).
